(19) United States
(12) Patent Application Publication
(10) Pub. No.: US 2017/0169108 A1
(43) Pub. Date: Jun. 15, 2017

(54) BRIGHT SPOT PROMPTING METHOD AND DEVICE BASED ON SEARCH KEY

(71) Applicants: Le Holdings (Beijing) Co., Ltd., Chao Yang District (CN); Le Shi Internet Information & Technology Corp., Beijing, Chao Yang District (CN)

(72) Inventor: Ying Liang, Chao Yang District (CN)

(21) Appl. No.: 15/241,403

(22) Filed: Aug. 19, 2016

Related U.S. Application Data
(63) Continuation of application No. PCT/CN2016/089573, filed on Jul. 10, 2016.

(30) Foreign Application Priority Data
Dec. 10, 2015 (CN) 201510915508.9

(51) Int. Cl. G06F 17/30; H04N 21/84; H04N 21/482; H04N 21/278

(52) U.S. Cl. CPC G06F 17/30843; G06F 17/30867; G06F 17/3082; H04N 21/278; H04N 21/84; H04N 21/4828

(57) ABSTRACT

Embodiments of this application relate to video optimization, and disclose a keyword search-based highlight prompt method and a keyword search-based highlight prompt device. Some of the embodiments of this application include: detecting information input by a user; extracting a keyword from the information input by the user, and retrieving, according to the keyword, a video containing a progress bar highlight of the keyword; and hiding a progress bar highlight of another keyword except for the keyword input by the user in the retrieved video, and displaying the progress bar highlight of the keyword input by the user. Some embodiments of this application may show a user a highlight prompt in a progress bar of a video according to content input by the user, so as to provide better user experience.

### CROSS-REFERENCE TO RELATED APPLICATIONS

The present disclosure is a continuation of PCT application No. PCT/CN2016/089573, and claims priority to Chinese Patent Application No. 2015109155089, filed with the Chinese Patent Office on Dec. 10, 2015, which is incorporated herein by reference in its entirety.

### TECHNICAL FIELD

Embodiments of this application relate to video optimization, and in particular to a keyword search-based highlight prompt method and an electronic device.

### BACKGROUND

At present, all video websites have a searching function. After a user inputs information that the user wants to search for, a great amount of videos about the information may appear, and the user needs to search for a video that the user wants to watch from the great amount of searched videos. Although a video is found according to the information input by the user, the following problems will still be brought in: the information input by the user only appears in a title of the video, and the content is not correlated; or a person or an object related to the information input by the user only appears for a short period of time, but the video lasts long, thereby causing great troubles and inconvenience to the user.

### SUMMARY

This application provides a keyword search-based highlight prompt method and providing an electronic device, where the keyword search-based highlight prompt method and the keyword search-based highlight prompt device may show a user a highlight prompt in a progress bar of a video according to content input by the user, so as to provide better user experience.

In a first aspect, an embodiment of this application provides a keyword search-based highlight prompt method, where the prompt method includes: detecting information input by the user; extracting a keyword from the information input by the user, and retrieving, according to the keyword, a video containing a progress bar highlight of the keyword; and hiding a progress bar highlight of another keyword except for the keyword input by the user in the retrieved video, and displaying the progress bar highlight of the keyword input by the user.

In a second aspect, an embodiment of this application provides a non-volatile computer storage medium, which stores a computer executable instruction, where execution of the instructions by the at least one processor causes the at least one processor to execute the keyword search-based highlight prompt method.

In a third aspect, an embodiment of this application provides an electronic device, including: at least one processor; and a memory for storing program executable by the at least one processor, where execution of the program by the at least one processor causes the at least one processor to execute any foregoing keyword search-based highlight prompt method of this application.

### BRIEF DESCRIPTION OF THE DRAWINGS

One or more embodiments are exemplarily described by using figures that are corresponding thereto in the accompanying drawings; the exemplary descriptions do not form a limitation to the embodiments. Elements with same reference signs in the accompanying drawings are similar elements. Unless otherwise particularly stated, the figures in the accompanying drawings do not form a scale limitation.

FIG. 1 is a flowchart of a keyword search-based highlight prompt method according to an embodiment of this application;

FIG. 2 is a structural schematic diagram of a keyword search-based highlight prompt device according to an embodiment of this application; and

FIG. 3 is a structural schematic diagram of an electronic device according to an embodiment of this application.

### DETAILED DESCRIPTION

The following describes in details some embodiments of this application with reference to the accompanying drawings. It should be noted that the specific implementation manners described herein are merely used to describe and explain this application, not to limit this application.

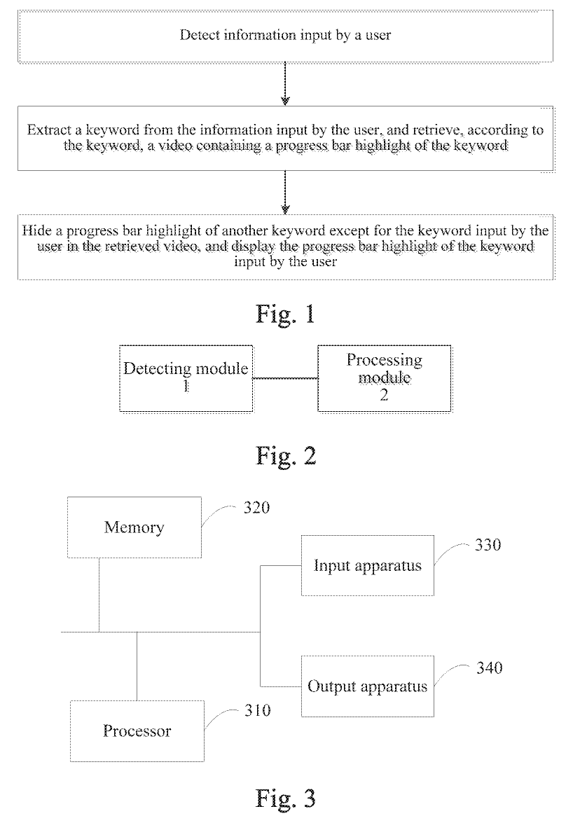

FIG. 1 is a flowchart of a keyword search-based highlight prompt method according to an implementation manner of this application. As shown in FIG. 1, an embodiment of this application provides a keyword search-based highlight prompt method. The prompt method includes: detecting information input by a user; extracting a keyword from the information input by the user, and retrieving, according to the keyword, a video containing a progress bar highlight of the keyword; and hiding a progress bar highlight of another keyword except for the keyword input by the user in the retrieved video, and displaying the progress bar highlight of the keyword input by the user. The keyword may be one or more of a scene, a place, and a name of a celebrity. Moreover, there may be one or more keywords.

First, progress bars of all videos are marked with highlights by a working personnel, and mark content includes a keyword. For example, if a celebrity appears at a time (e.g., 00:03:12), the name of the celebrity would be marked at the position in the progress bar; and another keyword may also be marked, for example, a scene and a place. The specific content represented by the keyword is determined by the type of the keyword marked by the working personnel.

After marking, each video has at least one progress bar highlight of a keyword. After a user inputs information, the information input by the user is detected, and a keyword is extracted from the information input by the user. Which type of keyword to identify and extract is determined by the foregoing keyword for marking the video (for example, if “the Louvre Museum” is not marked in advance, “the Louvre Museum” will not be identified and extracted). After the keyword is extracted (a plurality of keywords may be extracted), a video is retrieved according to the keyword, and the obtained video contains at least one progress bar highlight of the keyword. Moreover, a progress bar highlight of another keyword except for the keyword input by the user in the retrieved video is hidden, and the progress bar highlight of the keyword input by the user is displayed.

In addition, retrieving, according to the keyword, a video containing a progress bar highlight of the keyword further includes: retrieving, according to the keyword, a video displayed because of the information input by the user to obtain a video containing the progress bar highlight of the keyword and a video not containing the progress bar highlight of the keyword; and deleting the video not containing the progress bar highlight of the keyword.

After a user inputs information, a great amount of videos may be displayed by video websites, among which many are videos that the user does not want to watch. For example, some videos only include a keyword of the information input by the user in the title, and the content is not correlated. Therefore, according to an embodiment of this application, the displayed videos may further be filtered, so that a video not containing the progress bar highlight of the keyword input by the user is deleted while retrieving, among the videos, the video containing the progress bar highlight of the keyword. It is ensured that after the foregoing step of highlight hiding is implemented, only a video containing the progress bar highlight of the keyword input by the user is displayed to the user.

However, the processing method as above may still bring in the following problem: for example, the user wants to search for a television drama, but a name of the television drama does not carry a keyword, or contains a keyword that is not closely correlated with the television drama, which may possibly cause a situation in which the television drama is deleted from the search result instead of being displayed to the user. Therefore, in an embodiment of this application, if the information input by the user is a name of a film or a television drama, or is similar to a name of a film or a television drama, or further no keyword is detected in the information input by a user, the video not containing the progress bar highlight of the keyword is not deleted in the embodiment of this application.

FIG. 2 is a structural schematic diagram of a keyword search-based highlight prompt device according to an implementation manner of this application. As shown in FIG. 2, an embodiment of this application further provides a keyword search-based highlight prompt device. The prompt device includes: a detecting module 1, configured to detect, by a user, information input by the user; and a processing module 2, configured to extract a keyword from the information input by the user, retrieve, according to the keyword, a video containing a progress bar highlight of the keyword, hide a progress bar highlight of another keyword except for the keyword input by the user in the retrieved video, and display the progress bar highlight of the keyword input by the user. The keyword may be one or more of a scene, a place, and a name of a celebrity. Moreover, there is one or more keywords.

After a user inputs information, the detecting module 1 detects the information input by the user and sends the information input by the user to the processing module 2. The processing module 2 receives the information input by the user, extracts a keyword from the information input by the user, retrieves, according to the keyword, a video containing at least one progress bar highlight of the keyword, hides a progress bar highlight of another keyword except for the keyword input by the user in the retrieved video, and displays the progress bar highlight of the keyword input by the user.

In addition, retrieving, according to the keyword, a video containing a progress bar highlight of the keyword further includes: retrieving, according to the keyword, a video displayed because of the information input by the user to obtain a video containing the progress bar highlight of the keyword and a video not containing the progress bar highlight of the keyword; and deleting the video not containing the progress bar highlight of the keyword.

After the user inputs the information, a great amount of videos that the user does not want to watch may appear after the search of the processing module 2. For example, some videos only include a keyword of the information input by the user in the title, and the content is not correlated. Therefore, the processing module 2 may further filter the displayed videos. When retrieving, among those displayed videos, the video containing the progress bar highlight of the keyword, the processing module 2 deletes a video not containing the progress bar highlight of the keyword input by the user, and ensures that after highlight hiding, only a video containing the progress bar highlight of the keyword input by the user is displayed to the user.

However, if the processing module 2 determines that the information input by the user is a name of a film or a television drama, or is similar to a name of a film or a television drama, or further no keyword is detected in the information input by the user, the processing module 2 does not delete the video not containing the progress bar highlight of the keyword.

Embodiments of this application will be better described below according to two specific examples.

A user inputs “Andy Lau attends a release conference”. The detecting module 1 detects “Andy Lau attends a release conference” input by the user and sends the information to the processing module 2. The processing module 2 searches relative videos according to “Andy Lau attends a release conference” (the search is prior art, and details are not described herein) and meanwhile extracts a keyword “Andy Lau” from the “Andy Lau attends a release conference”, retrieves the relative videos according to the keyword “Andy Lau” to obtain some videos containing a progress bar highlight of the keyword “Andy Lau” and the other videos not containing the progress bar highlight of the keyword “Andy Lau”. The processing module 2 deletes the videos not containing the progress bar highlight of this keyword. Subsequently, the processing module 2 hides a progress bar highlight of another keyword except for the keyword “Andy Lau” in the videos containing the progress bar highlight of the keyword “Andy Lau”, and displays in the videos only the progress bar highlight of the keyword “Andy Lau”. Finally, the videos containing the progress bar highlight of the keyword “Andy Lau” are displayed to the user.

A user inputs “The Legend of Shaolin Temple”. The detecting module 1 detects “The Legend of Shaolin Temple” input by the user and sends the information to the processing module 2. The processing module 2 searches relative videos according to “The Legend of Shaolin Temple” (the search is prior art, and details are not described herein) and meanwhile, extracts a keyword “Shaolin Temple” from “The Legend of Shaolin Temple”, retrieves the relative videos according to the keyword “Shaolin Temple” to obtain some videos containing a progress bar highlight of the keyword “Shaolin Temple” and the other videos not containing the progress bar highlight of the keyword “Shaolin Temple”. Because the processing module 2 finds that “The Legend of Shaolin Temple” is a name of a television drama, the processing module 2 does not delete the videos not containing the progress bar highlight of the keyword “Shaolin Temple”; and the videos basically may be determined to be the television drama “The Legend of Shaolin Temple”. Subsequently, the processing module 2 hides a progress bar highlight of another keyword except for the keyword “Shaolin Temple” in the other videos containing the progress bar highlight of the keyword “Shaolin Temple”, and displays in the videos only the progress bar highlight of the keyword “Shaolin Temple”. Finally, the videos containing the progress bar highlight of the keyword “Shaolin Temple” and the other videos not containing the progress bar highlight of the keyword “Shaolin Temple” (the television drama “The Legend of Shaolin Temple”) are together displayed to the user.

The foregoing two examples respectively present the processing modes of the keyword search-based highlight prompt device provided in the embodiments of this application for the situations: the information input by the user contains the name of the television drama, and does not contain the name of the television drama, thereby causing no other troubles while providing convenience for the user.

According to the foregoing technical solutions, the keyword search-based highlight prompt method and the keyword search-based highlight prompt device provided in the embodiments of this application are used to: first, detect information input by a user; then, extract a keyword from the information input by the user, where there may be one or more keywords; retrieve, according to the keyword, a video containing a progress bar highlight of the keyword; and finally, display only the progress bar highlight of the keyword input by the user and hide the progress bar highlight of the another keyword. The keyword search-based highlight prompt method and the keyword search-based highlight prompt device provided in the embodiments of this application may show a user a highlight prompt in a progress bar of a video according to content input by the user, so as to provide better user experience.

An implementation manner of this application provides a non-volatile computer storage medium, which stores a computer executable instruction, where the computer executable instruction can execute the keyword search-based highlight prompt method in any one of the foregoing method embodiments.

FIG. 3 is a schematic structural diagram of hardware of an electronic device for executing a keyword search-based highlight prompt method provided in an implementation manner of this application. As shown in FIG. 3, the device includes:

one or more processors 310 and a memory 320, where only one processor 310 is used as an example in FIG. 3.

The keyword search-based highlight prompt device for executing the keyword search-based highlight prompt method may further include: an input apparatus 330 and an output apparatus 340.

The processor 310, the memory 320, the input apparatus 330, and the output apparatus 340 can be connected by means of a bus or in other manners. A connection by means of a bus is used as an example in FIG. 3.

As a non-volatile computer readable storage medium, the memory 320 can be used to store non-volatile software programs, non-volatile computer executable programs and modules, for example, a program instruction/module corresponding to the keyword search-based highlight prompt method in the embodiments of this application (for example, the detecting module 1 and the processing module 2 shown in FIG. 3). The processor 310 executes various functional applications and data processing of the server, that is, implements the keyword search-based highlight prompt method of the foregoing method embodiments, by running the non-volatile software programs, instructions, and modules that are stored in the memory 320.

The memory 320 may include a program storage area and a data storage area, where the program storage area may store an operating system and an application that is needed by at least one function; the data storage area may store data created according to use of the keyword search-based highlight prompt device, and the like. In addition, the memory 320 may include a high-speed random access memory, or may also include a non-volatile memory such as at least one disk storage device, flash storage device, or another non-volatile solid-state storage device. In some embodiments, the memory 320 optionally includes memories that are remotely disposed with respect to the processor 310, and the remote memories may be connected, via a network, to the keyword search-based highlight prompt device. Examples of the foregoing network include but are not limited to: the Internet, an intranet, a local area network, a mobile communications network, or a combination thereof.

The input apparatus 330 can receive entered digits or character information, and generate key signal inputs relevant to user setting and functional control of the keyword search-based highlight prompt device. The output apparatus 340 may include a display device, for example, a display screen.

The one or more modules are stored in the memory 320; when the one or more modules are executed by the one or more processors 310, the keyword search-based highlight prompt method in any one of the foregoing method embodiments is executed.

The foregoing product can execute the method provided in the embodiments of this application, and has corresponding functional modules for executing the method and beneficial effects. Refer to the method provided in the embodiments of this application for technical details that are not described in detail in this embodiment.

The electronic device in this embodiment of this application exists in multiple forms, including but not limited to:

(1) Mobile communication device: such devices are characterized by having a mobile communication function, and primarily providing voice and data communications; terminals of this type include: a smart phone (for example, an iPhone), a multimedia mobile phone, a feature phone, a low-end mobile phone, and the like;

(2) Ultra mobile personal computer device: such devices are essentially personal computers, which have computing and processing functions, and generally have the function of mobile Internet access; terminals of this type include: PDA, MID and UMPC devices, and the like, for example, an iPad;

(3) Portable entertainment device: such devices can display and play multimedia content; devices of this type include: an audio and video player (for example, an iPod), a handheld game console, an e-book, an intelligent toy and a portable vehicle-mounted navigation device;

(4) Server: a device that provides a computing service; a server includes a processor, a hard disk, a memory, a system bus, and the like; an architecture of a server is similar to a universal computer architecture. However, because a server needs to provide highly reliable services, requirements for the server are high in aspects of the processing capability, stability, reliability, security, extensibility, and manageability; and

(5) Other electronic apparatuses having a data interaction function.

The apparatus embodiment described above is merely exemplary, and units described as separated components may be or may not be physically separated; components presented as units may be or may not be physical units, that is, the components may be located in a same place, or may be also distributed on multiple network units. Some or all modules therein may be selected according to an actual requirement to achieve the objective of the solution of this embodiment.

Through description of the foregoing implementation manners, a person skilled in the art can clearly learn that each implementation manner can be implemented by means of software in combination with a universal hardware platform, and certainly, can be also implemented by using hardware. Based on such understanding, the essence, or in other words, a part that makes contributions to relevant technologies, of the foregoing technical solutions can be embodied in the form of a software product. The computer software product may be stored in a computer readable storage medium, for example, a ROM/RAM, a magnetic disk, or a compact disc, including several instructions for enabling a computer device (which may be a personal computer, a sever, or a network device, and the like) to execute the method in the embodiments or in some parts of the embodiments.

Finally, it should be noted that: the foregoing embodiments are only used to describe the technical solutions of this application, rather than limit this application. Although this application is described in detail with reference to the foregoing embodiments, a person of ordinary skill in the art should understand that he/she can still modify technical solutions disclosed in the foregoing embodiments, or make equivalent replacements to some technical features therein; however, the modifications or replacements do not make the essence of corresponding technical solutions depart from the spirit and scope of the technical solutions of the embodiments of this application.

1. A keyword search-based highlight prompt method, applied to a terminal, wherein the prompt method comprises:
detecting information input by a user;
extracting a keyword from the information input by the user, and retrieving, according to the keyword, a video containing a progress bar highlight of the keyword; and
hiding a progress bar highlight of another keyword except for the keyword input by the user in the retrieved video, and displaying the progress bar highlight of the keyword input by the user.

2. The keyword search-based highlight prompt method according to claim 1, wherein the keyword is one or more of a scene, a place, and a name of a celebrity.

3. The keyword search-based highlight prompt method according to claim 1, wherein there is one or more keywords.

4. The keyword search-based highlight prompt method according to claim 1, wherein the retrieving, according to the keyword, a video containing a progress bar highlight of the keyword comprises:
retrieving, according to the keyword, a video displayed because of the information input by the user to obtain a video containing the progress bar highlight of the keyword and a video not containing the progress bar highlight of the keyword; and deleting the video not containing the progress bar highlight of the keyword.

5. The keyword search-based highlight prompt method according to claim 4, further comprising: if the information input by the user is a name of a television drama or film, or does not comprise any keyword, not deleting the video not containing the progress bar highlight of the keyword.

6-10. (canceled)

11. A non-volatile computer storage medium, which stores a computer executable instruction, wherein the computer executable instruction is used for:
detecting information input by a user;
extracting a keyword from the information input by the user, and retrieving, according to the keyword, a video containing a progress bar highlight of the keyword; and
hiding a progress bar highlight of another keyword except for the keyword input by the user in the retrieved video, and displaying the progress bar highlight of the keyword input by the user.

12. The non-volatile computer storage medium according to claim 11, wherein the keyword is one or more of a scene, a place, and a name of a celebrity.

13. The non-volatile computer storage medium according to claim 11, wherein there is one or more keywords

14. The non-volatile computer storage medium according to claim 11, wherein the retrieving, according to the keyword, a video containing a progress bar highlight of the keyword comprises:
retrieving, according to the keyword, a video displayed because of the information input by the user to obtain a video containing the progress bar highlight of the keyword and a video not containing the progress bar highlight of the keyword; and deleting the video not containing the progress bar highlight of the keyword.

15. The non-volatile computer storage medium according to claim 14, wherein the computer executable instruction is further used for: if the information input by the user is a name of a television drama or film, or does not comprise any keyword, not deleting the video not containing the progress bar highlight of the keyword.

16. An electronic device, comprising:
at least one processor; and
a memory communicably connected with the at least one processor for storing instructions executable by the at least one processor,
wherein execution of the instructions by the at least one processor causes the at least one processor to:
detect information input by a user;
extract a keyword from the information input by the user, and retrieving, according to the keyword, a video containing a progress bar highlight of the keyword; and
hide a progress bar highlight of another keyword except for the keyword input by the user in the retrieved video, and displaying the progress bar highlight of the keyword input by the user.

17. The electronic device according to claim 16, wherein the keyword is one or more of a scene, a place, and a name of a celebrity.

18. The electronic device according to claim 16, wherein there is one or more keywords.

19. The electronic device according to claim 16, wherein the retrieving, according to the keyword, a video containing a progress bar highlight of the keyword comprises:
retrieving, according to the keyword, a video displayed because of the information input by the user to obtain a video containing the progress bar highlight of the keyword and a video not containing the progress bar highlight of the keyword; and deleting the video not containing the progress bar highlight of the keyword.

20. The electronic device according to claim 19, wherein the at least one processor is further capable of: if the information input by the user is a name of a television drama or film, or does not comprise any keyword, not deleting the video not containing the progress bar highlight of the keyword.
